(19) United States
(12) Patent Application Publication
(10) Pub. No.: US 2026/0118523 A1
(43) Pub. Date: Apr. 30, 2026

(54) COMPUTER-IMPLEMENTED METHOD FOR DETERMINING A POSITION OF A USER, COMPUTER-READABLE MEDIUM AND INERTIAL NAVIGATION SYSTEM

(71) Applicant: Robert Bosch GmbH, Stuttgart (DE)

(72) Inventors: Ivan Melendez Vazquez, Herrenberg (DE); Juergen Gut, Tuebingen (DE)

(21) Appl. No.: 19/362,811

(22) Filed: Oct. 20, 2025

(30) Foreign Application Priority Data
Oct. 25, 2024 (DE) 10 2024 210 303.9

(51) Int. Cl. G01S 19/49

(52) U.S. Cl. CPC G01S 19/49

(57) ABSTRACT

A computer-implemented method for determining a position of a user. In a first step, a first sensor signal, which represents an acceleration acting at the position of the user, is detected using at least one inertial sensor. In a second step, at least one frequency-filtered sensor signal is determined using bandpass filtering of the first sensor signal. In a third step, a correction signal, which represents a pedestrian speed of the user, is determined using the at least one frequency-filtered sensor signal. In a fourth step, navigation data, which represent the position and/or speed of the user, are ascertained according to the correction signal and the first sensor signal by using Kalman filtering in accordance with the pedestrian speed represented by the correction signal. A computer-readable medium including instructions for performing the method and an inertial navigation system configured accordingly are also described.

### CROSS REFERENCE

The present application claims the benefit under 35 U.S.C. § 119 of Germany Patent Application No. DE 10 2024 210 303.9 filed on Oct. 25, 2024, which is expressly incorporated herein by reference in its entirety.

### FIELD

The present invention relates to a computer-implemented method for determining a position of a user, a computer-readable medium comprising instructions for performing the method with the aid of an evaluation device and an inertial navigation system configured to perform the method.

### BACKGROUND INFORMATION

An inertial navigation system (INS) provides 3D orientation, speed and position information from a given starting state using inertial sensors (inertial measurement unit, IMU), in particular on the basis of microelectromechanical systems (MEMS). Theoretically, a precise estimation of the orientation, speed and position of the user could be achieved on the basis of error-free sensor signals. However, inertial sensors, in particular MEMS sensors, are susceptible to a plurality of sources of error, including, for example, offsets, scale factors, non-orthogonality of the inertial sensors used and the like.

A conventional method for correcting the navigation data provided by an inertial navigation system is to link the output of the navigation data to consistency with external data. For example, global navigation satellite systems (GNSS) can be used to correct the position and speed of an inertial navigation system. These approaches require a good GNSS signal, which may not be available when navigating indoors, in cities or in other locations.

One method for correcting navigation data from an inertial navigation system is to use pedometry data, such as the speed of users. For example, U.S. Patent Application Publication No. US 2014/0194138 A1 describes determining the position of the inertial navigation system with the aid of an external pedometer.

### SUMMARY

It is an object of the present invention to provide an improved method for determining the position of a user by means of an inertial navigation system. It is a particular object of the present invention to provide an inertial navigation system that makes possible a precise position determination even in regions without sufficient connection to a satellite navigation system, such as in the interior regions of buildings or the like.

This object may be achieved by a computer-implemented method for determining a position of a user, a computer-readable medium, and an inertial navigation system, having certain features of the present invention. Advantageous embodiments of the present invention are disclosed herein.

One aspect of the present invention relates to the precise estimation of a pedestrian speed of a user, in particular a pedestrian. According to an example embodiment of the present invention, the method uses step detection based on sensor signals of an inertial navigation system, wherein first sensor signals corresponding to an acceleration are detected by at least one inertial sensor at the position of the user. An error parameter assigned to the pedestrian speed is provided in order to indicate the magnitude of the correction to the position determination of the inertial navigation system based on the solution of equations of motion.

According to an example embodiment of the present invention, the computer-implemented method for determining the position of the user comprises the steps of:
detecting a first sensor signal that represents an acceleration acting at the position of the user, by means of at least one of the inertial sensors:
determining at least one frequency-filtered sensor signal by means of bandpass filtering of the first sensor signal;
determining a correction signal that represents a pedestrian speed of the user using the at least one frequency-filtered sensor signal;
ascertaining navigation data that represent the position and/or speed of the user according to the correction signal and the first sensor signal by means of Kalman filtering in accordance with the pedestrian speed represented by the correction signal.

This approach is precise and robust and, in particular, provides reliable step detection independent of the positioning of the at least one inertial sensor on the body of the user. This is achieved in that a frequency spectrum or frequency band relevant to locomotion activities of the first sensor signal provided by the at least one inertial sensor is considered. Therefore, any other type of movement, such as a hand swing, does not affect the performance of the step detection. Precise step detection therefore provides the ability to reliably ascertain a pedestrian speed corresponding to the movement of the user.

A frequency band relevant for locomotion activities lies in particular between 1.3 Hz and 3.2 Hz. According to the type of locomotion, the frequency bands for example between 1.6 Hz to 2.1 Hz and/or 2.3 Hz to 2.8 Hz have proven to be suitable for step detection.

The proposed algorithm of the present invention has a very low power consumption, since it uses only the acceleration vector, in particular the three-dimensional acceleration vector, as the input signal and comparatively simple signal processing techniques are applied. In particular, no use of external pedometers is necessary, since the correction is based on the evaluation of the sensor signals provided by the inertial sensors. This also eliminates the need to qualify the inertial navigation system with pedometers of different designs. This furthermore results in reduced overhead during data transmission, since in particular the shared use of data via Bluetooth can lead to increased power consumption.

In a preferred example embodiment of the present invention, the locomotion activity of the user is classified using the sensor signals provided by the inertial sensors. Such a classification of the locomotion activity is preferably carried out using a first and a second frequency-filtered sensor signal, which are determined by means of bandpass filtering of the first sensor signal such that the first frequency-filtered sensor signal contains components of the first sensor signal of a first frequency band, whereas the second frequency-filtered sensor signal contains components of the first sensor signal of a second frequency band. In order to ensure the significance of the classification, it has been found to be advantageous if the first and second frequency bands do not overlap. In particular, in this context, the first frequency band can be specified by the frequency range between 1.6 Hz to 2.1 Hz and the second frequency band by the frequency range between 2.3 Hz to 2.8 Hz.

A further aspect of the present invention relates to a computer-readable medium comprising instructions for performing the method according to the present invention presented here for determining the position of the user, and an inertial navigation system designed accordingly.

Further details and advantages of the present invention are explained in more detail below with reference to the exemplary embodiments shown in the figures.

### BRIEF DESCRIPTION OF THE DRAWINGS

FIG. 1 is a schematic representation of an inertial navigation system according to one possible exemplary embodiment of the present invention.

FIG. 2 shows a process-related embodiment of step detection based on sensor signals from inertial sensors, according to an example embodiment of the present invention.

FIG. 3 shows a frequency spectrum of a sensor signal that corresponds to a movement on foot.

FIG. 4 shows a frequency spectrum of a sensor signal that corresponds to a movement on foot and a simultaneously moved hand.

FIG. 5 shows the profile of a pedestrian speed ascertained using the sensor signals compared to a corresponding GNSS speed and an average GNSS speed.

FIG. 6 shows a process-related embodiment of a classification of a locomotion activity based on the sensor signals of the inertial sensors, according to an example embodiment of the present invention.

FIG. 7 shows the relative error of the position determination according to a process-related embodiment of the present invention compared to a conventional procedure for various applications.

Identical or corresponding elements are provided with the same reference signs in all figures.

It is understood that the diagrams and figures contained herein illustrate the basic features of the present invention. It is further understood that flowcharts, flow diagrams, pseudocodes and the like represent various processes that can be substantially represented in a computer-readable medium and executed in a computer, a processor, a microprocessor, a circuit, in particular an integrated circuit, or more generally in an evaluation device 20 configured for data processing, regardless of whether or not such an evaluation device 20 is represented.

### DETAILED DESCRIPTION OF EXAMPLE EMBODIMENTS

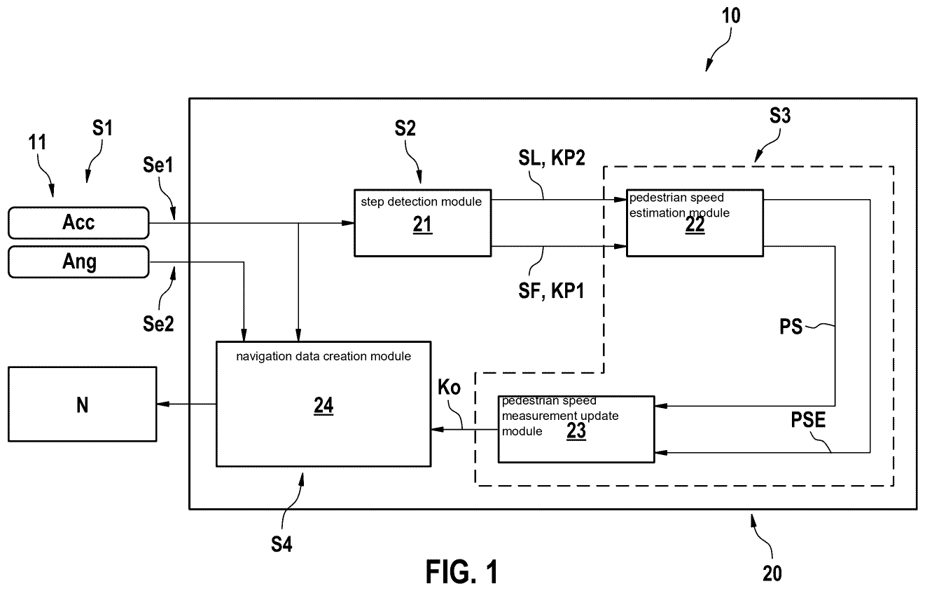

FIG. 1 illustrates the architecture of the approach according to the present invention proposed here for optimizing a solution of an inertial navigation system 10 during locomotion on foot. The presented method for determining the position of a user of the inertial navigation system 10 comprises step detection, estimating the pedestrian speed and updating the pedestrian speed measurement with the aid of pedometry data that are detected by means of at least one inertial sensor 11 of the inertial navigation system 10 itself. In this sense, the pedometry data used here can also be regarded as intrinsic data of the inertial navigation system 10.

The inertial navigation system 10 comprises, in addition to the at least one inertial sensor 11 for detecting the acceleration Acc acting at the position of the user, an evaluation device 20 that has a first module 21 for step detection, a second module 22 for estimating a pedestrian speed PS assigned to the user, a third module 23 for updating the pedestrian speed measurement and a fourth module 24 for creating navigation data N reflecting the position and/or speed of the user. In embodiments, at least one control signal is generated according to the navigation data N. In some embodiments, the navigation data N can be output via an interface (not shown further).

In a first step S1, a first sensor signal Se1, which represents the acceleration Acc acting at the position of the user, is detected by means of inertial sensors 11.

In a second step S2, at least one frequency-filtered sensor signal Sef1, Sef2 is determined by means of bandpass filtering of the first sensor signal Se1.

In a third step S3, a correction signal Ko, which represents a pedestrian speed of the user, is determined using the at least one frequency-filtered sensor signal Sef1, Sef2.

In a fourth step S4, the navigation data N, which represent the position and/or speed of the user, are ascertained according to the correction signal Ko and the first sensor signal Se1 by means of Kalman filtering in accordance with the pedestrian speed represented by the correction signal Ko. Optionally, in the fourth step S4, additional second sensor signals Sef2, which represent rotation rates Ang, are taken into account when ascertaining the navigation data N.

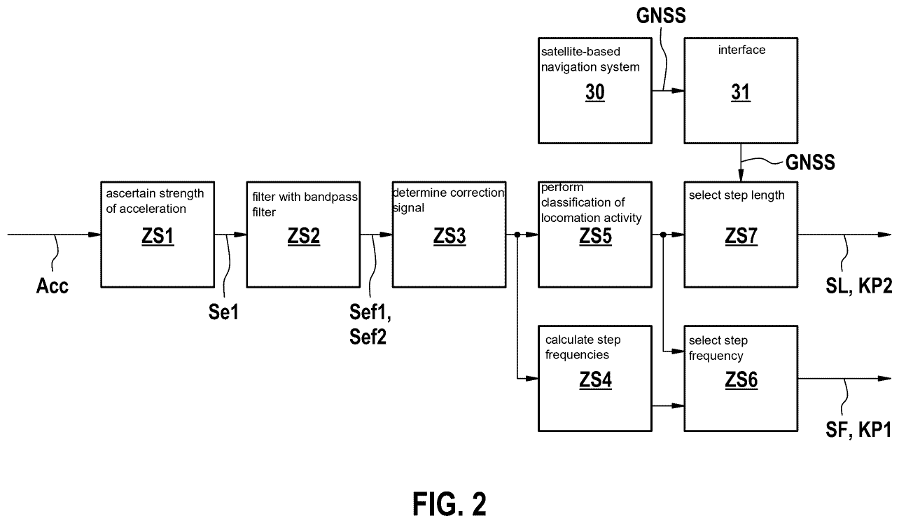

The approach for step detection proposed here is shown schematically in FIG. 2. The concept of step detection is based on filtering out frequencies that do not correspond to the step movements of the user, such as hand movements.

For step detection, the strength of the acceleration Acc is initially ascertained as the first sensor signal Se1 in a first intermediate step ZS1 and subsequently filtered in a second intermediate step ZS2 by means of a bandpass filter, in particular by means of a second-order Butterworth bandpass filter, in order to generate a first and a second frequency-filtered sensor signal Sef1, Sef2. The first frequency-filtered sensor signal Sef1 contains the signal components of the first sensor signal Se1 in a first frequency band between 1.6 Hz and 2.1 Hz.

The first frequency band can be assigned to a walking movement of the user. The second frequency-filtered sensor signal Sef2 contains the signal components of the first sensor signal Se1 in a second frequency band between 2.3 Hz and 2.8 Hz. The second frequency band can be assigned in particular to a running movement such as jogging. The frequency bands relevant for the various locomotion activities were ascertained using a proprietary dataset that comprises over 500 case studies with approximately 20 different users, wherein the inertial navigation system 10 comprising the inertial sensor 11 was worn on the wrist, on the arm, in a pants pocket or in the hand.

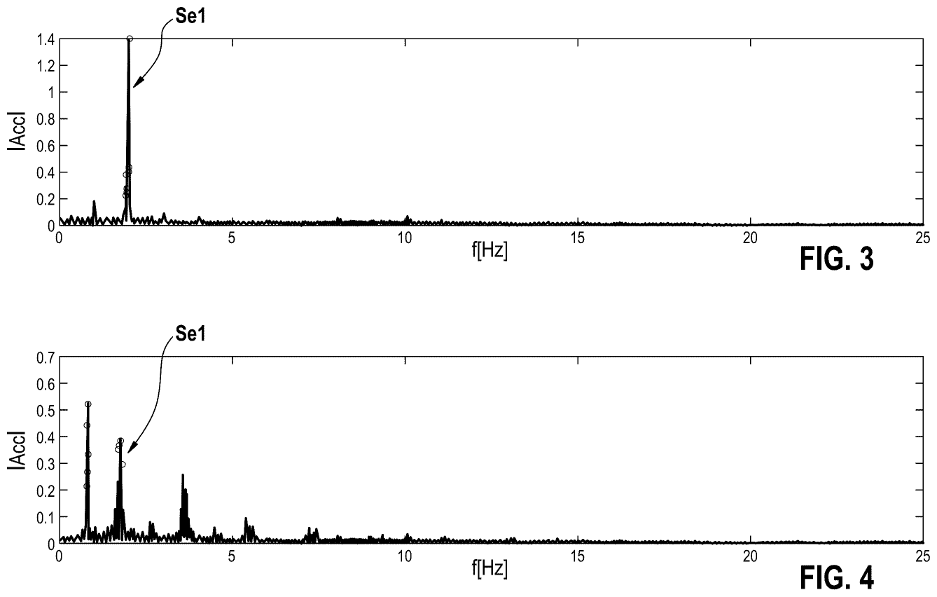

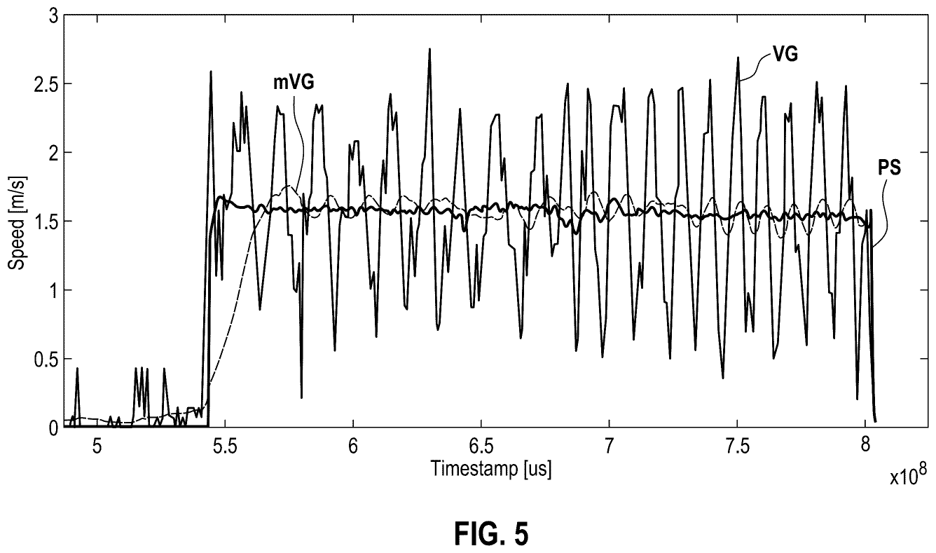

FIG. 3 shows the frequency spectrum of a first sensor signal Se1, which corresponds to the norm of the acceleration Acc in the case that the inertial sensor 11 is held in the hand and no other type of movement, apart from locomotion on foot, is performed. In this case, the frequency spectrum shows a single frequency peak. On the other hand, the frequency spectrum exhibits a plurality of frequency peaks when the user moves the hand while walking or jogging, as can be seen in FIG. 4.

The identification of steps using the unfiltered first sensor signal Se1 is generally not possible, since the corresponding signatures in the unfiltered signal cannot be distinguished from other movement patterns, in particular those caused by a hand swing. However, by bandpass filtering, it can be achieved that the frequency-filtered sensor signal Sef1, Sef2 substantially corresponds to a sine wave, the amplitude and frequency of which are determined by steps of the user. Based on the frequency-filtered sensor signal Sef1, Sef2, reliable step detection can therefore be implemented.

The step detection (see FIG. 2) can be performed in the third intermediate step ZS3 by means of edge detection of the filtered sensor signal Sef1, Sef2, in particular by means of positive edge detection of the filtered sensor signal Sef1, Sef2, wherein in particular a control signal corresponding to the step detection can be generated.

In a fourth intermediate step ZS4, step frequencies SF are calculated in accordance with the filtered sensor signal Sef1, Sef2. Such a step frequency SF can be ascertained in particular using the filtered sensor signal Sef1, Sef2 as the inverse of the time difference between two detected steps. The step frequency SF represents a first correction parameter KP1, wherein the correction signal Ko is determined according to the first correction parameter KP1. The step detection is preferably performed for the first and the second filtered sensor signals Sef1, Sef2 in order to monitor the signals provided by the inertial sensors 11 with regard to step frequencies SF corresponding to the movement types of walking and running (jogging).

In order to correctly select the step frequency SF and a step length SL according to the current application, a classification of the locomotion activity of the user is performed in a fifth intermediate step ZS5.

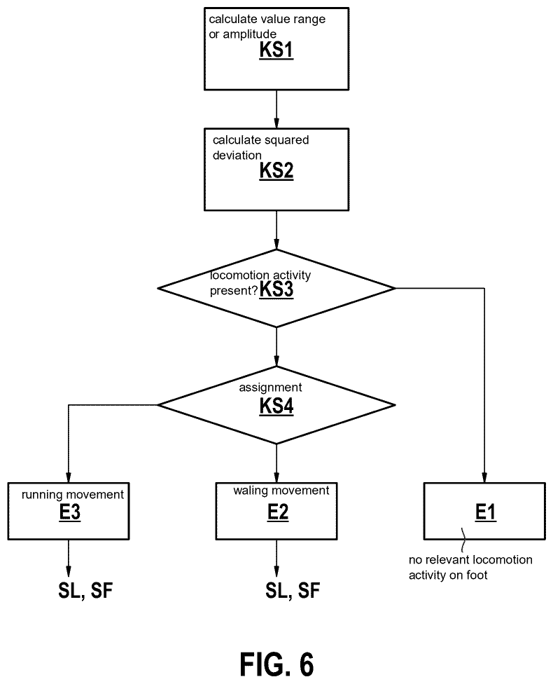

The logic of this classification is shown schematically in FIG. 6. When classifying locomotion activity, classification results E1, E2, E3 are determined. For this purpose, if a step has been detected, i.e. if a step could be recognized, the value range or amplitude of the first and second filtered sensor signals Sef1, Sef2 is calculated in a first classification step KS1. Then, in a second classification step KS2, the squared deviation of these amplitudes is calculated. Using a comparison of this quadratic deviation from a threshold value, a third classification step KS3 decides whether locomotion activity is present. If the user is neither walking nor running or jogging, the corresponding amplitudes of the first and second filtered sensor signals Sef1, Sef2 are small. This requires that the squared deviation of these amplitudes be below a specified or specifiable threshold value. In this way, it can be determined that the user is not performing any relevant locomotion activity on foot. This corresponds to the first classification result E1. On the other hand, the squared deviation increases as the user starts walking or running. A relevant locomotion activity can thus be identified by the squared deviation being above the specified or specifiable threshold value.

The assignment of the classification results E2, E3, which concern the locomotion activity with regard to the type of movement, such as walking or running, is carried out in a fourth classification step KS4 in accordance with the frequency-filtered sensor signal Sef1, Sef2 with the largest amplitude. If the amplitude of the first frequency-filtered sensor signal Sef1 is greater than the amplitude of the second frequency-filtered sensor signal Sef2, the second classification result E2, which corresponds to a walking movement, is assigned to the locomotion activity. If the amplitude of the first frequency-filtered sensor signal Sef1 is smaller than the amplitude of the second frequency-filtered sensor signal Sef2, the third classification result E3, which corresponds to a running movement, is assigned to the locomotion activity.

Using the assigned locomotion activity or the classification result E2, E3, the correct step frequency SF is subsequently selected in a sixth intermediate step ZS6 (see FIG. 2) and step length SL in a seventh intermediate step ZS7. The step length SL represents a second correction parameter KP2, wherein the correction signal Ko is determined according to the second correction parameter KP2. According to possible exemplary embodiments, the step length SL is assumed to be constant for a given type of locomotion. For example, the step length SL when walking corresponds to a specified value of 0.85 m and the step length SL when jogging corresponds to a specified value of 1.10 m.

Optionally, the step length SL can be determined or optimized with the aid of an external GNSS signal GNSS of a satellite-based navigation system 30, wherein the external GNSS signal GNSS is transmitted via an interface 31 of the inertial navigation system 10. In this case, the step length SL can be ascertained using the following relationship:

$$stepLength = gnssSpeed / stepFrequency \qquad ( 1 )$$

Here, “stepLength” denotes the step length SL, “gnssSpeed” the speed ascertained by the satellite-based navigation system 30 and “stepFrequency” denotes the step frequency SL ascertained using the first or second frequency-filtered sensor signal Sef1, Sef2.

The pedestrian speed is determined by the relationship

$$pedestrianSpeed = stepFrequency * stepLength \qquad ( 2 )$$

where “pedestrianSpeed” denotes the pedestrian speed PS and “stepLength” denotes the step length SL.

In an alternative embodiment, this linear relationship can be replaced by a nonlinear function of the form

$$pedestrianSpeed = f ( stepFrequency , stepLength ) \qquad ( 3 )$$

which depends on the step frequency SF and the step length SL.

FIG. 5 shows an example of the pedestrian speed PS estimated with the aid of this approach. For comparison, FIG. 5 shows the profile of the instantaneous GNSS speed VG detected by the satellite-based navigation system 30 and the profile of the average GNSS speed mVG. It can be seen clearly that the pedestrian speed PS ascertained using the frequency-filtered sensor signal Sef1, Sef2 substantially corresponds to the average GNSS speed.

The pedestrian speed error PSE is determined by the relationship pedestrianSpeedError=pedestrianSpeedStdev+errorFactor (4) where pedestrianSpeedError denotes the pedestrian speed error PSE. The pedestrian speed error PSE depends mainly on the standard deviation of the pedestrian speed PS, which is reflected by the factor “pedestrianSpeedStdev.” An additional error parameter “errorFactor” was introduced so that the pedestrian speed error PSE is always greater than zero. For example, if the pedestrian speed PS is almost constant, the standard deviation is very small and the pedestrian speed error PSE can be almost zero.

The speed ascertained by the fourth module 24 of the inertial navigation system 10 is given by

$${v}_{k} = {v}_{k - 1} + a c {c}_{l i n} * dt , \qquad ( 5 )$$

where vₖ denotes the three-dimensional speed vector of the k-th iteration, vₖ₋₁ the three-dimensional speed vector of the previous, (k−1)-th iteration, accₗᵢₙ the linear acceleration and dt the time difference between two integration steps.

The approach presented here focuses on correcting the magnitude or norm of the speed in the horizontal plane. The norm of the speed in the horizontal plane is given by

$${v}_{{n}_{k}} = \sqrt{{{v}_{{x}_{k}}}^{2} + {{v}_{{y}_{k}}}^{2}} , \qquad ( 6 )$$

where vₓ_{ₖ} denotes the speed component in the X-direction and v_{y}_{ₖ} denotes the speed component in the Y-direction. The corrected norm of speed \hat{v}ₙ_{ₖ} is calculated as follows:

$${\hat{v}}_{{n}_{k}} = {v}_{{n}_{k - 1}} + K ( {p}_{k} - {v}_{{n}_{p r e d}} ) \qquad ( 7 )$$

Here, pₖ denotes the pedestrian speed PS estimated in the k-th iteration, in particular according to equation (2) or (3) and vₙ_{_{pred}} denotes the predicted norm of the speed. The quantity (pₖ−vₙ_{_{pred}}) is referred to as the measurement residual. K describes the Kalman gain, which is given by

$$K = {P}_{k} {{H}^{T} ( H {P}_{k} {H}^{T} + R )}^{- 1} , \qquad ( 8 )$$

where P denotes the state covariance matrix, H the state-to-measurement matrix and R the measurement covariance matrix. The measurement covariance matrix R is calculated here with the aid of equation (4) for the pedestrian speed error PSE. As R approaches zero, the Kalman gain K weights the measurement residual more heavily, resulting in a stronger correction of the norm of the speed.

This measurement update corrects the norm of the speed vₙ_{ₖ} in the horizontal plane, which is used to correct the speed vₖ of the user. The correction of the speed vₖ of the user results in the position information exhibiting fewer cumulative errors after integration. If sensor errors, preferably all sensor errors, in particular with respect to deviating orientations of the inertial sensors 11, are included in the state or as state variables of the probabilistic filter, then the correction specified in equation (7) also affects these sensor errors, resulting in an improved estimation of the sensor orientations and sensor errors.

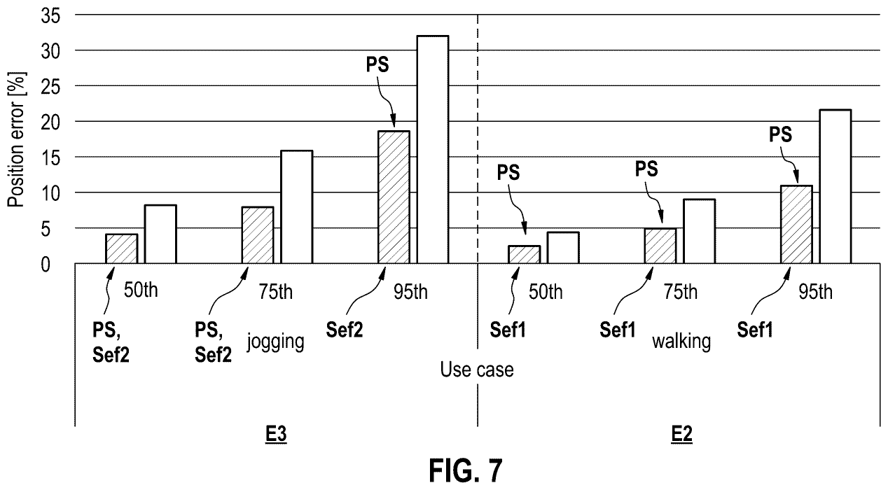

FIG. 7 shows a comparison of the position error contained in the navigation data N. The cumulative relative position errors after 50, 75 and 95 steps for two different cases are shown. The case is shown in which the navigation data N are ascertained without boundary conditions, i.e., without correction in accordance with the pedestrian speed PS. In contrast, the case is shown (hatched) in which the navigation data N are ascertained consistently with the pedestrian speed PS as a boundary condition. The relative position errors are given both for walking according to the second classification result E2 and for running (jogging) according to the third classification result E3. In the case that the pedestrian speed PS is taken into account as a boundary condition for position determination according to the method proposed here, the relative position errors are consistently smaller, which indicates increased navigation accuracy.

What is claimed is:

1. A computer-implemented method for determining a position of a user, the method comprising the following steps:
in a first step, detecting, using at least one inertial sensor, a first sensor signal which represents an acceleration acting at the position of the user;
in a second step, determining, using bandpass filtering of the first sensor signal, at least one frequency-filtered sensor signal;
in a third step, determining using the at least one frequency-filtered sensor signal, a correction signal, which represents a pedestrian speed of the user;
in a fourth step, ascertaining navigation data which represent the position and/or a speed of the user, according to the correction signal and the first sensor signal using Kalman filtering by a Kalman filter in accordance with the pedestrian speed represented by the correction signal.

2. The method according to claim 1, wherein the pedestrian speed, when ascertaining the navigation data in the fourth step, represents a boundary condition for the speed of the user in a horizontal plane.

3. The method according to claim 1, wherein, in the second step, the first sensor signal is filtered in a frequency band between 1.3 Hz and 3.2 Hz.

4. The method according to claim 1, wherein, in the second step, the at least one frequency-filtered sensor sensor includes a first and a second frequency-filtered sensor signal, the first and second frequency filter sensor signals being determined using the bandpass filtering of the first sensor signal, wherein the first frequency-filtered sensor signal contains components of the first sensor signal of a first frequency band and the second frequency-filtered sensor signal contains components of the first sensor signal of a second frequency band, wherein the first and second frequency bands do not overlap.

5. The method according to claim 4, wherein, in the third step, step detection is carried out using an edge detection of the at least one frequency-filtered sensor signal, wherein the navigation data are determined in the fourth step upon step detection according to the correction signal.

6. The method according to claim 5, wherein, in the third step, a first correction parameter representing a step frequency is ascertained using the at least one frequency-filtered sensor signal, wherein the correction signal is determined according to the first correction parameter.

7. The method according to claim 6, wherein the step detection is carried out using the first and the second frequency-filtered sensor signal, wherein the first and the second frequency-filtered sensor signal are classified with regard to an existing locomotion activity and the first correction parameter representing the step frequency is determined according to a classification result of the locomotion activity.

8. The method according to claim 7, wherein the classification of the present locomotion activity is carried out by comparing a quantity derived from the first frequency-filtered sensor signal and the second frequency-filtered sensor signal including a quadratic deviation, with a threshold value.

9. The method according to claim 6, wherein a second correction parameter representing a step length is specified or determined according to an external GNSS signal of a satellite-based navigation system, and the correction signal is determined according to the first and the second correction parameters, wherein the pedestrian speed is determined as a function of the first and second correction parameters.

10. The method according to claim 9, wherein the correction signal is determined iteratively taking into account the first and/or the second correction parameter determined in a preceding iteration step and/or a quantity derived as a function of the first and second correction parameters including the pedestrian speed.

11. The method according to claim 6, wherein a pedestrian speed error assigned to the correction signal, which quantifies a sensor error of the at least one inertial sensor, is determined by comparing the pedestrian speed with a speed ascertained by integration of the first sensor signal.

12. The method according to claim 10, wherein the pedestrian speed, when ascertaining the navigation data in the fourth step, represents a boundary condition for the speed of the user in a horizontal plane, and wherein, in the fourth step, a norm of the speed in the horizontal plane is corrected in accordance with the first and/or the second correction parameter and/or the quantity derived as a function of the first and second correction parameters including the pedestrian speed, wherein the norm of the speed in the horizontal plane thus ascertained is used to correct the navigation data representing the position and/or speed of the user, ascertained using the Kalman filtering.

13. The method according to claim 1, wherein, in the fourth step, sensor errors, with respect to deviating orientations of inertial sensors, are taken into account as state variables of the Kalman filter and are ascertained according to the correction signal and the first sensor signal using the Kalman filtering in accordance with the pedestrian speed represented by the correction signal.

14. A non-transitory computer-readable medium on which are stored instructions that, when executed by an evaluation device, cause the evaluation device to execute a computer-implemented method for determining a position of a user, the method comprising the following steps:
in a first step, detecting, using at least one inertial sensor, a first sensor signal which represents an acceleration acting at the position of the user;
in a second step, determining, using bandpass filtering of the first sensor signal, at least one frequency-filtered sensor signal;
in a third step, determining using the at least one frequency-filtered sensor signal, a correction signal, which represents a pedestrian speed of the user;
in a fourth step, ascertaining navigation data which represent the position and/or a speed of the user, according to the correction signal and the first sensor signal using Kalman filtering using a Kalman filter in accordance with the pedestrian speed represented by the correction signal.

15. An inertial navigation system for determining a position of a user, comprising:
at least one inertial sensor configured to detect an acceleration acting at a position of a user and to provide a first sensor signal which represents the acceleration acting at the position of the user; and
an evaluation device configured to determine a frequency-filtered sensor signal by bandpass filtering the first sensor signal, to determine a correction signal using the at least one frequency-filtered sensor signal, and to ascertain navigation data representing the position of the user according to the correction signal and the first sensor signal using Kalman filtering.

16. The inertial navigation system according to claim 15, further comprising:
an external interface configured to transmit an external GNSS signal of a satellite-based navigation system.

17. The inertial navigation system according to claim 15, wherein the navigation data are additionally ascertained by Kalman filtering according to a second sensor signal representing a rotation rate.
